(19) United States
(12) Patent Application Publication
(10) Pub. No.: US 2002/0191674 A1
(43) Pub. Date: Dec. 19, 2002

(54) Temperature showable filler cap for engine radiator

(76) Inventor: Chih-Hsiung Lee, Pan-Chiao City (TW)

Correspondence Address: SUPREME PATENT SERVICES, POST OFFICE BOX 2339, SARATOGA, CA, 95070, US

(21) Appl. No.: 09/881,629

(22) Filed: Jun. 13, 2001

(51) Int. Cl. G01K 1/14; G01K 13/00; G01K 5/62

(52) U.S. Cl. 374/146; 374/207; 116/216

(57) ABSTRACT

A temperature showable filler cap for engine radiator is composed of a filler cap, a thermometer, and a fixing ferrule, wherein a storing space is formed in a central portion of the filler cap for accommodating the thermometer, which is fixedly positioned with the fixing ferrule. A readout index is placed on the top end of the thermometer whose bottom end is extended downwardly to form a thermal sensing portion deep into the radiator to sense inside temperature and quantify to show on the readout index on the filler cap to keep a user informed of the temperature in the radiator to avoid scalding.

### FIELD OF THE INVENTION

This invention relates to a filler cap, particularly to a temperature showable filler cap for engine radiator that can show temperature degrees of an engine radiator distinctly and directly in order to prevent a car-user from being scalded.

### BACKGROUND OF THE INVENTION

It is a common sense that a driver should refrain from opening the filler cap of a hot radiator, which is also cautioned by words set on the cap and in every driver's handbook. In other words, the filler cap can be opened only after the radiator has been cooled down to a harmless temperature.

The problem is: “How low is the optimum temperature for a user to open the cap safely?” Judging by vision with experience seems an option however with less reliability, instead, a temperature showable filler cap of this invention that can tell exact temperature degrees of the cooling water distinctly and directly at any time may be a better choice to effectively avoid scalding.

### SUMMARY OF THE INVENTION

The primary object of this invention is to provide a temperature showable filler cap for engine radiator, wherein a thermometer is disposed in a generic filler cap to indicate the temperature of liquid contained in a radiator to ensure security.

For more detailed information regarding advantages or features of this invention, at least an example of preferred embodiment will be elucidated below with reference to the annexed drawings.

### BRIEF DESCRIPTION OF THE DRAWINGS

The related drawings in connection with the detailed description of this invention, which is to be made later, are described briefly as follows, in which:

FIG. 1 is a schematic view of a temperature showable filler cap for engine radiator of this invention in three dimensions; and

FIG. 2 is a partially exploded view of the temperature showable filler cap for engine radiator in three dimensions.

### DETAILED DESCRIPTION OF THE INVENTION

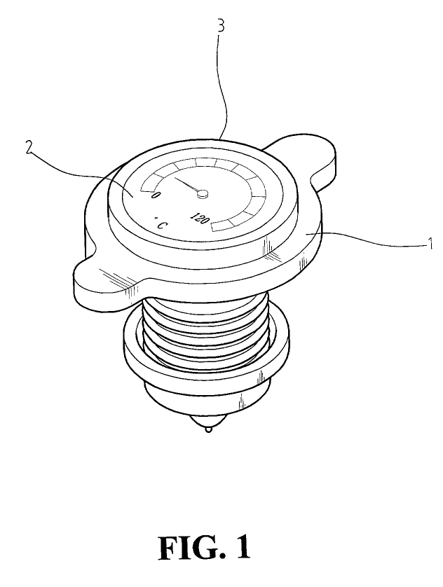

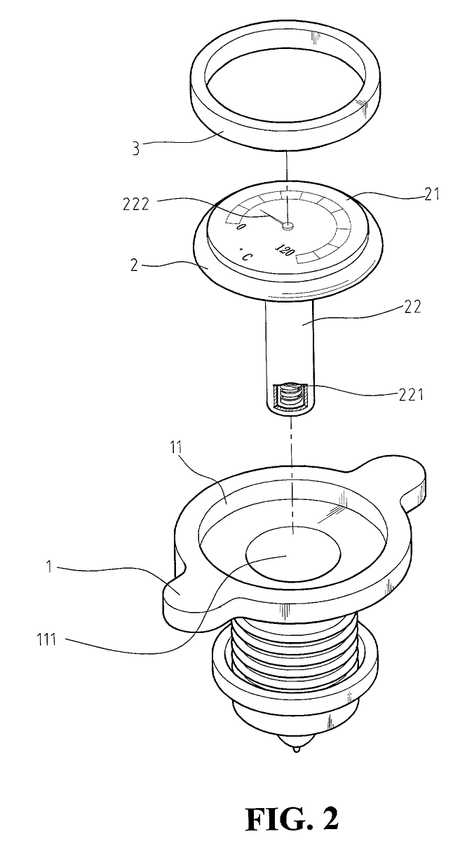

As illustrated in the enclosed FIGS. 1 and 2, a temperature showable filler cap for engine radiator of this invention mainly comprises a filler cap 1, a thermometer 2, and a fixing ferrule 3. The main structure of the filler cap 1 is about the same with a conventional one, hence repeated description is waived.

The key point of the filler cap structure of this invention is that a storing space 11 is formed in the central portion of the filler cap 1 for accommodating the main body of the thermometer 2, wherein a smaller space 111 is further reserved in the central portion to permit a thermal sensing portion 22 at the bottom end of the thermometer 2 to extend downwardly for measuring temperature inside the radiator.

The thermometer 2 is basically a mechanical induction thermometer, wherein a readout index 21 is positioned on its top end; the bottom end of the thermometer 2 is extended downwardly to form the metallic thermal sensing portion 22 with an inside thermal sensing piece 221, which is heated to stretch out and meanwhile drive a pointer 222 to rotate and quantify to show the variation on the readout index 21. The main body of the thermometer 2 is made of a metallic material in order to resist against high temperature and pressure, and the thermometer 2 may be classified in two categories: one is filled with oil and covered with a PC (Polycarbonate) made transparent window; the other is not filled with oil but covered with anti-fog glass to keep a transparent window without being fogged under high temperature for easy observation.

The fixing ferrule 3 is provided to match with dimensions of the storing space 11 of the filler cap 1 for fixedly anchoring the thermometer 2 at the top end of the filler cap 1 and holding it tightly.

The filler cap 1 of this invention can be fitted to a generic engine radiator, and the heat in the radiator is conducted to the entire body of the metallic filler cap 1, wherein the thermal sensing portion 22 is heated to drive the pointer 222 and show the temperature inside the radiator on the readout index 21, which may be divided into a warning zone and a safe zone for easy discrimination with a quick glance.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. A temperature showable filler cap for engine radiator, comprising:
a filler cap having a storing space formed in the central portion thereof for accommodating a thermometer;
a thermometer having a readout index disposed at a top end thereof and a bottom end of the thermometer being extended downwardly through a smaller space reserved in the central portion of the storing space to form a thermal sensing portion to reach inside of a radiator; and
a fixing ferrule placed on top of the thermometer in the storing space of the filler cap to keep the thermometer immovable.

2. The temperature showable filler cap according to claim 1, wherein the thermometer is filled with oil and covered with a PC (Polycarbonate) made transparent window for easy observation.

3. The temperature showable filler cap according to claim 1, wherein the thermometer is not filled with oil but covered with anti-fog glass to keep a transparent window for easy observation.

4. The temperature showable filler cap according to claim 1, wherein the readout index of the thermometer is divided into a warning zone and a safe zone.
